(19) United States
(12) Patent Application Publication
(10) Pub. No.: US 2020/0272159 A1
(43) Pub. Date: Aug. 27, 2020

(54) METHOD AND VEHICLE CONTROL SYSTEM FOR INTELLIGENT VEHICLE CONTROL ABOUT A ROUNDABOUT

(71) Applicant: DENSO International America, Inc., Southfield, MI (US)

(72) Inventors: Wei ZHANG, Novi, MI (US); Rajesh MALHAN, Troy, MI (US); Joseph LULL, South Haven, MI (US)

(73) Assignee: DENSO International America, Inc., Southfield, MI (US)

(21) Appl. No.: 16/524,816

(22) Filed: Jul. 29, 2019

Related U.S. Application Data
(60) Provisional application No. 62/809,928, filed on Feb. 25, 2019.

(51) Int. Cl. G05D 1/02; G06N 3/08

(52) U.S. Cl. CPC G05D 1/0221; G06N 3/08; G05D 1/0291; G05D 1/0223

(57) ABSTRACT

The present disclosure is directed toward a method that includes defining a roundabout path plan for a subject vehicle based on roundabout characteristics and dynamic characteristics, among other data. The method further determines whether a platoon can be formed with at least one surrounding vehicle based on the roundabout path plan, and calculates an entry parameter for the platoon based on dynamic traffic flow of the roundabout and a predictive control in response to determining that the platoon can be formed. The method collaborates and verifies the entry parameter with the platoon to obtain an agreed entry parameter.

### CROSS-REFERENCE TO RELATED APPLICATIONS

This application claims priority to and the benefit of U.S. Provisional Application No. 62/809,928 filed on Feb. 25, 2019. The disclosure of the above application is incorporated herein by reference.

### FIELD

The present disclosure relates to a system and/or method for controlling a vehicle through a roundabout.

### BACKGROUND

The statements in this section merely provide background information related to the present disclosure and may not constitute prior art.

Roundabouts generally have fewer conflict points than that of conventional intersections. For example, a single lane roundabout can have 8 conflict points whereas a two-lane bidirectional flow intersection can have 32 conflict points. Roundabouts also promote smoother continuous traffic flow at lower speed, which can decrease the impact of an accident should an incident occur. However, low and inconsistent speed of vehicles traversing through the roundabout can cause congestion and is a common issue with roundabouts. These and other issues are addressed by the present disclosure.

### SUMMARY

This section provides a general summary of the disclosure and is not a comprehensive disclosure of its full scope or all of its features.

In one form, the present disclosure is directed toward a method that includes: defining a roundabout path plan for a subject vehicle based on roundabout characteristics, dynamic characteristics, an entry point of the roundabout, an exit point of the roundabout, or a combination thereof; determining whether a platoon can be formed with at least one surrounding vehicle based on the roundabout path plan; calculating an entry parameter for the platoon in response to determining that the platoon can be formed based on dynamic traffic flow of the roundabout and a predictive control; collaborating and verifying the entry parameter with the platoon to obtain an agreed entry parameter; and controlling the subject vehicle to enter the roundabout based on the agreed entry parameter. The entry parameter includes an entry time and an occupancy gap, and the predictive control is configured to predict position and path of the subject vehicle and the at least one surrounding vehicle based on the dynamic characteristics.

In one form, the present disclosure is directed toward a vehicle control system for a subject vehicle. The vehicle control system includes a controller configured to: define a roundabout path plan for traversing a roundabout based on roundabout characteristics, dynamic characteristics of the subject vehicle, an exit point of the roundabout, or a combination thereof; determine whether a platoon can be formed with at least one surrounding vehicle based on the roundabout path plan; calculate an entry parameter for the platoon in response to determining that the platoon can be formed based on dynamic traffic flow of the roundabout and a predictive control, where the entry parameter includes an entry time and an occupancy gap between members of the platoon, and the predictive control is configured to predict position and path of the subject vehicle and the at least one surrounding vehicle based on dynamic characteristics; collaborate and verify the entry parameter with the platoon to obtain an agreed entry parameter; and control the subject vehicle to enter the roundabout based on the agreed entry parameter.

In one form, the present disclosure is directed toward a method that includes: determining dynamic traffic flow of the roundabout based on dynamic characteristics, where the dynamic characteristics include information related to one or more vehicles entering a roundabout; defining a roundabout path plan for each of the one or more vehicles based on an entry point of the vehicle, an exit point of the vehicle, or a combination thereof; calculating an entry parameter for the one or more vehicles based on the traffic flow and a predictive control, where the entry parameter includes an entry time and an occupancy gap for having the vehicle enter the roundabout, and the predictive control is configured to predict position and path of each of the vehicles; and transmitting the entry parameter and the roundabout path plan to respective vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system having a roundabout and multiple vehicles in accordance with the teachings of the present disclosure;

FIG. 2 is a block diagram of the system of FIG. 1;

FIG. 3 is a block diagram of a roundabout control system in accordance with the teachings of the present disclosure;

FIG. 4 is a block diagram of a vehicle having an autonomous drive module in accordance with the teachings of the present disclosure;

FIG. 5 is a block diagram of the autonomous drive module of the vehicle of FIG. 4;

FIG. 6 is a block diagram of a roundabout control application of the autonomous drive module of FIG. 5;

FIGS. 7A, 7B, and 7C illustrate a roundabout with multiple vehicles entering, traversing, and/or exiting the roundabout via the roundabout control application in accordance with teachings of the present disclosure;

FIG. 8 is a block diagram of a roundabout control system having a roundabout control application in accordance with teachings of the present disclosure;

FIG. 9 is a flowchart of a roundabout control routine for a vehicle in accordance with teachings of the present disclosure; and

FIG. 10 is a flowchart of a roundabout control routine for a roundabout control system vehicle in accordance with teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure describes a roundabout control application for an autonomous vehicle to predict and plan an approach of the vehicle and to control the vehicle as it enters and traverses through the roundabout. The roundabout control application controls the traffic flow through the roundabout and may improve traffic flow, efficiency, and safety by regulating roundabout occupancy by real-time scheduling of vehicles entering and exiting the roundabout. In one form, a system provided at a roundabout includes a communication network that supports data exchange between, for example, vehicle and infrastructure. For autonomous vehicles within the system, the roundabout control application may collaborate in path planning and voluntarily cooperate for safe and efficient travel through the traffic roundabout.

In the following, dynamic characteristics includes characteristics of a moving object provided about the roundabout and includes but is not limited to vehicles, pedestrians, and/or cyclists. Based on the type of moving object, the dynamic characteristics may include, but is not limited to location, speed, distance, travel direction, and/or acceleration. In one form, the dynamic characteristics for a given object can be provided by the moving object such as vehicle transmitting a message and/or determined using data from sensors, moving objects, roadside unit, and/or other devices. In addition, in the following, the phrase “through a/the roundabout” may include steps of the vehicle entering the roundabout, traversing the roundabout, and/or exiting the roundabout.

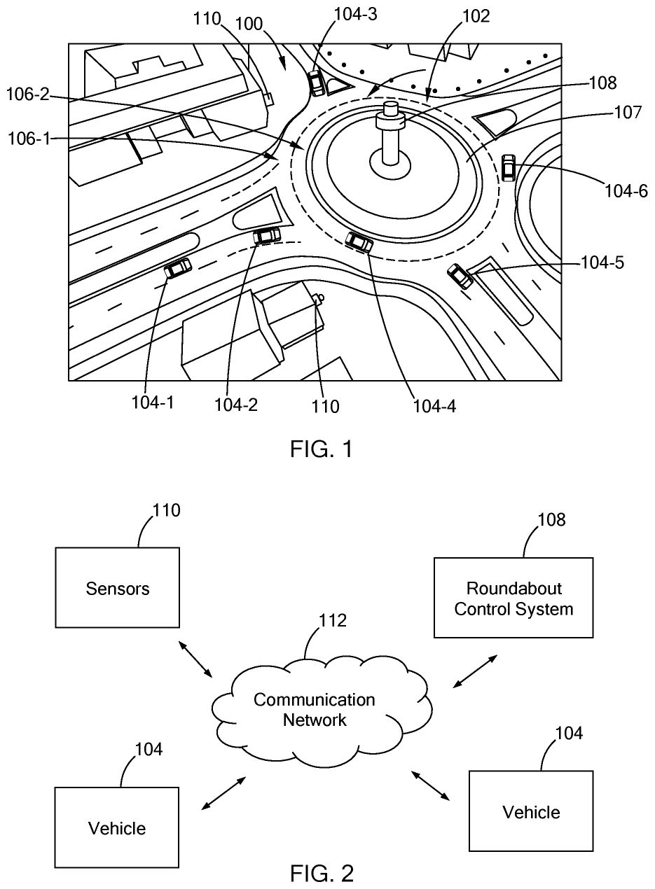

FIGS. 1 and 2 illustrate an example system 100 in which a roundabout 102 is approached by vehicles 104-1 to 104-3 and traversed by vehicles 104-4 to 104-6 (vehicles 104 collectively). The roundabout 102 has two lanes 106-1 and 106-2 and an island 107. In one form, the roundabout 102 includes a roundabout control system 108 for determining or mapping dynamic traffic flow about the roundabout 102. The roundabout 102 may be configured in various suitable ways and should not be limited to the example provided herein. For example, the roundabout 102 may have one or more lanes, pedestrian cross-walks/islands, bicycle lanes, traffic lights, among other characteristics. In another variation, the roundabout 102 may not include roundabout control system 108 while remaining within the scope of the present disclosure.

In one form, all of the vehicles 104 are provided as fully-autonomous vehicles in which a user may enter a destination and a vehicle control system drives the vehicle 104 to the destination based on a defined travel route. In another form, the vehicles 104 have different levels of automation that include, for example, fully-autonomous, semi-autonomous (e.g., conditional automation and/or high automation), and/or manually operated (e.g., no automation, driver assistance, partial automation). Additional details regarding the type of vehicles described herein is provided in J3016-Automation Levels by Society of Automotive Engineers (SAE).

The system 100 may further include one or more sensors 110 disposed at or around the roundabout 102 to monitor the environment about the roundabout 102. For example, FIG. 1 illustrates sensors 110-1 and 110-2 (collectively sensors 110) arranged at buildings located about the roundabout 102. In one form, the sensors 110 are configured to detect and/or identify objects; determine position, speed, and/or direction of an identified object that may be stationary or moving; and/or detect weather conditions, such as precipitation, fog, and/or sun. Sensors performing such tasks may include, but are not limited to, cameras, radar, LIDAR, infrared sensors, ultrasonic sensors, and/or weather sensors (thermometer, barometer, and hygrometer, among others). While specific examples are provided, other types of data such as latency delays, may be detected to assist in determining or mapping a dynamic traffic flow about the roundabout 102 and guiding the vehicles 104 through the roundabout 102.

The system 100 may also support device-to-device communication which incorporates vehicle-to-everything communication links (i.e., vehicle-to-vehicle, vehicle-to-infrastructure, vehicle-to-network, and vehicle-to-pedestrian among other communication links) by way of a communication network 112. In one form, the communication network 112 may encompass wireless computer network (e.g., dedicated short-range communication (DSRC)), cellular network (e.g., 3GPP and 5G), and/or satellite communication. Accordingly, the system 100 may include gateways, routers, base stations, satellites, intermediary communication devices, among other components to support the communication network 112.

Devices connected to the communication network 112 may exchange different types of information based on the type of device. As an example, a vehicle 104 connected to the network 112 (i.e., a connected vehicle) may transmit a message that includes information to identify the connected vehicle, and characteristics of the vehicle 104 such as location (e.g., coordinates and/or elevation), speed, travel direction, acceleration, and/or brake system status. In one form, to improve bandwidth and reduce computational load, devices may select data, such as a location, speed, and travel direction. With this information, other connected vehicles may identify and track movement of the vehicle that transmitted the message. In another form, the devices connected to the communication network 112 may perform computational tasks using raw data.

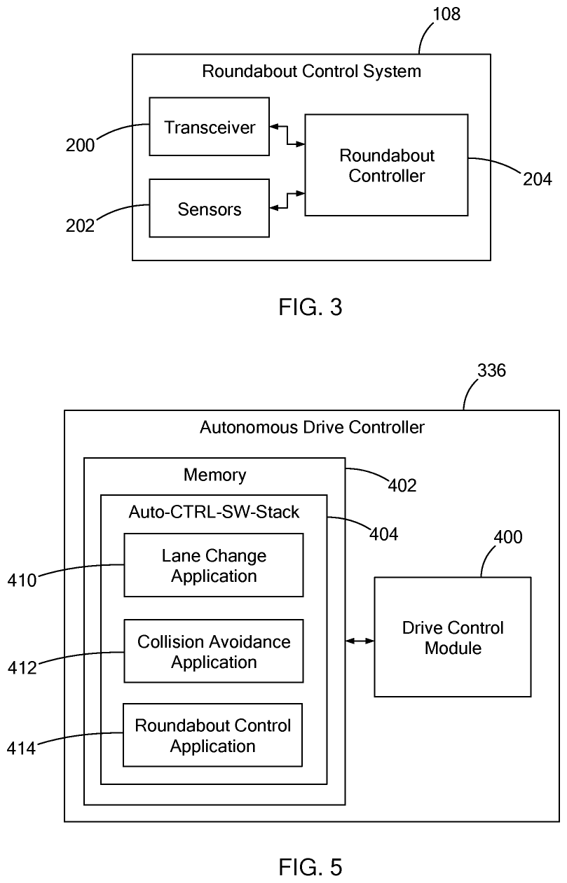

Referring to FIG. 3, the roundabout control system 108 is configured to monitor traffic about the roundabout 104 and exchange data with surrounding devices such as the vehicles 104 and/or sensors 110. In one form, the roundabout control system 108 includes a communication device 200, one or more sensors 202, and a roundabout controller 204. The communication device 200 is configured to operate with other devices in the system 100 via the network 112, and thus, may include a router or transceiver, among other components.

The sensors 202 are configured to provide a full view of objects approaching and traversing the roundabout 102. In one form, the sensors 202 are mounted at the roundabout 102 at a height sufficient to acquire a full view (i.e., 360 degrees) of the roundabout 102. The sensors 202 may include cameras, radar, LIDAR, infrared sensors, ultrasonic sensors, and sensor arrays, among others. In one variation, in lieu of or in addition to the sensors 202, the sensors 110 are provided at one or more locations about the roundabout 102 as a distributed network to provide the 360-degree full view without the sensors 202 or in combination with the sensors 110.

In one form, the roundabout controller 204 is a computing device mounted at the roundabout 102. In another form, the roundabout controller 204 is part of a cloud-based network comprising servers configured to store data and compute traffic characteristics, such as arterial traffic density and traffic flow, among other information. The roundabout controller 204 is provided at the cloud edge in vicinity of the roundabout 102 to perform calculations related to the roundabout 102.

The roundabout controller 204 is configured to store information or a map regarding the configuration of the roundabout 102 such as the type, size, number of lanes, number of exits, and geometry, among other information, which is generally referred to as roundabout characteristics. The roundabout characteristics may be transmitted to vehicles 104 for planning a travel path through the roundabout 102.

In one form, the roundabout controller 204 is configured to analyze data from the sensors 202 and other devices (e.g., vehicles 104 and sensors 110) to identify objects about the roundabout 102, and determine characteristics of the objects, such as position, speed, and travel directions. The roundabout controller 204 transmits a message regarding the identified objects to the vehicles 104. More particularly, in one form, the roundabout controller 204 transmits a message regarding a moving object that is not connected to the wireless network 112 such as an unconnected vehicle, pedestrian, cyclist, etc. In one form, if the moving object is a vehicle, the message transmitted may be a proxy basic safety message (BSM) that conforms to, for example, SAE J2735 protocol. If the moving object is not a vehicle but a pedestrian, cyclist, etc., the message transmitted may be a proxy personal safety message (PSM) and/or may be a proxy vulnerable road user safety message that conforms to, for example, SAE J2735 or J2945/9 protocol. While specific example messaging protocols are provided, other messaging protocols may be used and are within the scope of the present disclosure.

The roundabout controller 204 may be configured in various suitable ways to perform specific tasks and is not limited to functions described herein. For example, a roundabout controller may only transmit roundabout characteristics, and does not transmit messages regarding detected objects. In another example, the roundabout controller 204 is configured to map the dynamic traffic flow of the roundabout and transmit roundabout path plans to the vehicles, as described herein.

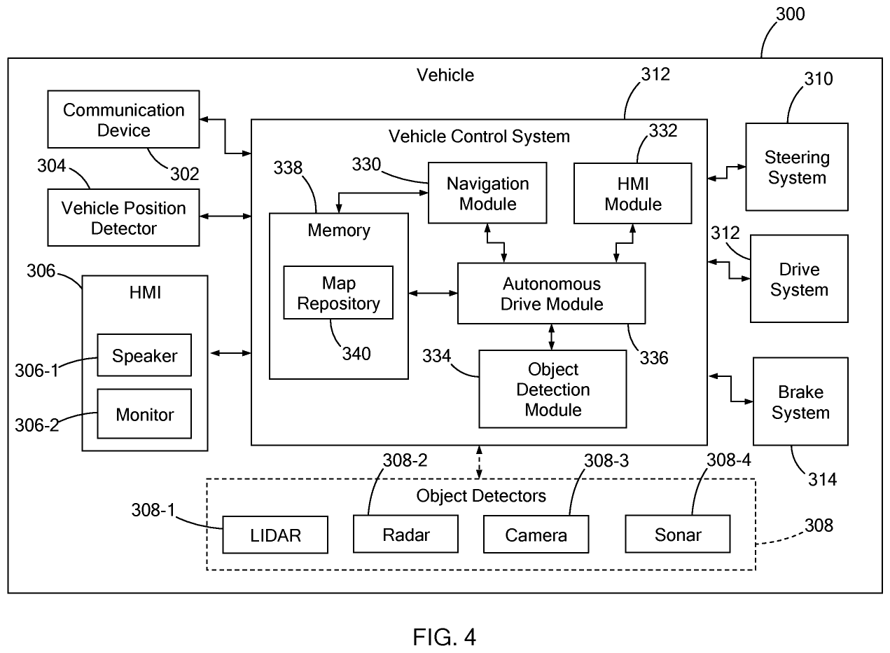

Referring to FIG. 4, an example block diagram is provided of a vehicle 300 that is an autonomous vehicle having a roundabout control application of the present disclosure. The vehicles 104 of FIG. 1 may be configured as vehicle 300. In one form, the vehicle 300 includes a communication device 302, a vehicle position detector 304, a human machine interface (HMI) 306, one or more object detector 308, and a vehicle control system 312. The communication device 302 is configured to exchange data with other devices in the system 100 via the communication network 112. In one form, the communication device 302 includes a transceiver (not shown) for connecting to the communication network 112 and a controller having memory and a microprocessor for processing messages received and generating messages to be transmitted. For example, the communication device 302 is configured to transmit a message to other devices that identifies the vehicle 300 and provides selected characteristics of the vehicle 300, such as position, speed, and travel direction. This message can be provided as a BSM defined by SAE J2735 BSM protocol or other suitable vehicle messaging protocol.

The vehicle position detector 304 is configured to determine the location of the vehicle 300 and may include a GPS antenna. The vehicle control system 312 utilizes the vehicle location to determine travel routes to a selected destination and drives the vehicle 300 to the destination based on a selected travel route.

The HMI 306 is configured to provide information and/or entertainment and receive commands from a passenger. The HMI 306 is typically provided within a passenger cabin of the vehicle 300, and may include a speaker 306-1, a monitor 306-2 (e.g., liquid crystal display), and/or devices such as touchscreen, buttons, and/or knobs (not shown).

The object detectors 308 are arranged about the vehicle 300 and are configured to detect objects about the vehicle 300, which include stationary and moving objects. For example, the object detectors 308 are operable to detect objects such as other vehicles 104, traffic markers (e.g., lane markings, signs, among others), pedestrians, vegetation, and road barriers, among others. In one form, the object detectors 202 may include a LIDAR 308-1, a radar 308-2, a camera 308-3, an ultrasonic sensor 308-4, and/or a combination thereof. It should be readily understood that other suitable object detectors may also be used and should not be limited to the examples provided herein.

The vehicle control system 312 encompasses various controllers that are configured to control different sub-systems within the vehicle such as, but not limited to, the HMI 306, a steering system 310, a drive system 312, and a brake system 314. The steering system 310 includes a series of components such as a steering wheel, steering angle sensors, and powered steering gears, for moving the vehicle 300 based on a rotation of the steering wheel provided by a driver. The drive system 320 is configured to generate and deliver power to the wheels of the vehicle 300 to move the vehicle 300. Based on the type of vehicle 300, the drive system 312 includes components such as, but not limited to, engine, transmission, battery system, electric motors, wheels, suspension, converter/generator, actuators, and/or sensors for detecting speed/velocity, wheel angle, and vehicle heading. The brake system 322 is operable to slow the vehicle 300 based on a control command from the vehicle control system 312 and/or an input from the driver. Based on the type of brake system (e.g., regenerative, hydraulic, etc.), the brake system 322 may include components such as, but not limited to pedal, brakes, disc, and/or brake controllers. While specific sub-systems are illustrated, the vehicle 300 may include other sub-systems. In addition, based on the level of autonomous control, the vehicle 300 may not include a steering system, a brake pedal, and/or an acceleration pedal.

In one form, the vehicle control system 312 includes a navigation module 330, an HMI module 332, an object detection module 334, an autonomous drive module 336, and a memory 338 for storing a map repository 340. Vehicle control system 312 may include one or more controllers that are configured as the modules 330, 332, 334, and 336. The one or more controllers may include a processor circuit, a memory circuit for storing code executed by the processor circuit, and other suitable hardware components to provide the described functionality of the modules 330, 332, 334, and 336. While specific modules are illustrated, the vehicle control system 312 may include other modules for controlling the vehicle 300 and should not be limited to the modules described herein.

The navigation module 330 is configured to determine travel routes to a destination based on the location of the vehicle 300 and maps provided in the map repository 340. In one form, the destination is provided by a user via the HMI 306, a software application associated with the vehicle 300, or other suitable method. In one form, the map repository 342 stores various navigational maps that illustrate roads, transit routes, points of interest, and other suitable information. The map repository 340 may also store characteristics of the road, such as road curvature, road height, intersection layout, roundabout characteristics, traffic direction (e.g., one-way travel, or two-way), and/or number of lanes along the road.

The HMI module 332 is configured to operate the devices of the HMI 306 to provide information to passengers of the vehicle 300. For example, the HMI module 332 controls the monitor 306-2 to display messages regarding destination (e.g., address, names), the travel route, and vehicle speed, among other information.

The object detection module 334 is configured to detect objects about the vehicle 300 and determines dynamic characteristics of moving objects such as, but not limited to, the type of object detected, position, speed, distance, and/or trajectory. In one form, the object detection module 334 detects and/or identifies objects based on data from the object detectors 308. As an example, the object detectors 308 may emit a signal having predefined properties (e.g., frequency, waveform, amplitude, etc.), and receive a signal that is reflected off an object, such as an adjacent vehicle. The object detection module 334 is configured to analyze the signals transmitted and received to determine whether an object is present, and if so, determines one or more dynamic characteristics if the object is moving, which can be determined using multiple sets of transmitted and received signals.

The object detection module 334 may also identify objects about the vehicle 300 based on messages from external devices via the communication network. For example, other vehicles coupled to the communication network may transmit messages that provide a vehicle ID, speed, travel direction, and/or position to notify other devices of its presence. In another example, the roadside units, like the roundabout control system and sensors, may transmit messages to identify objects they have detected, which may include vehicles and/or pedestrians that are connected and not connected to the communication network. Using data from various sources, the objection detection module 334 is configured to identify objects and determine dynamic characteristics of the objects such as speed, trajectory (i.e., travel direction), and position, among others.

In one form, the autonomous drive module 336 is configured to provide a fully-autonomous control of the vehicle 300 by controlling various vehicle sub-systems. Referring to FIG. 5, in one form, the autonomous drive module 336 includes a drive control module 400 and a memory 402 for storing an autonomous control software stack 404 (“Auto-CTRL-SW-Stack” in figure). The drive control module 400 is configured to execute one or more applications stored in the autonomous control software stack 404 to provide control commands to the vehicle sub-systems such as the drive system 320 and/or the brake system 322.

The autonomous control software stack 404 includes various software applications for performing various driving maneuvers such as adjusting the speed of the vehicle, altering travel direction, changing lanes, avoiding objects, joining platoons, and/or other suitable actions. In one form, the autonomous control software stack 404 includes a lane change application 410, a collision avoidance application 412, and a roundabout control application 414. It should be readily understood that while specific applications are illustrated, the stack 404 may include other applications and should not be limited to the examples described herein.

The lane change application 410 is configured to move the vehicle 300 from a first drive lane to a second drive lane based on the travel route of the vehicle 300. The collision avoidance application 412 is configured to inhibit a collision and/or reduce collision impact with a pedestrian, a vehicle, and/or other object. For example, the collision avoidance application 412 assesses potential collisions with an object detected by the object detection module based on information from the object detection module 334. The collision avoidance application 412 may determine countermeasures to have the vehicle 300 avoid the collision or mitigate impact. As described in detail herein, the roundabout control application 414 is configured to determine a roundabout path plan and an entry time for the vehicle 300 to enter and traverse through a roundabout as part of a platoon or by itself.

The roundabout control application 414 may be executed when the vehicle 300 approaches a roundabout. As an example, using the travel route defined by the navigation module 330 and travel maps in the map repository 340, the autonomous drive module 336 identifies any roundabouts provided along the travel route and is configured to execute the roundabout control application 414 when the vehicle 300 is a defined distance and/or time away from the roundabout (e.g., 10 to 100 m, 1 min, 30 secs). In one form, a combination of vehicle speed, time, distance, and/or speed limit may be used to assess the distance and/or duration a vehicle is from the roundabout.

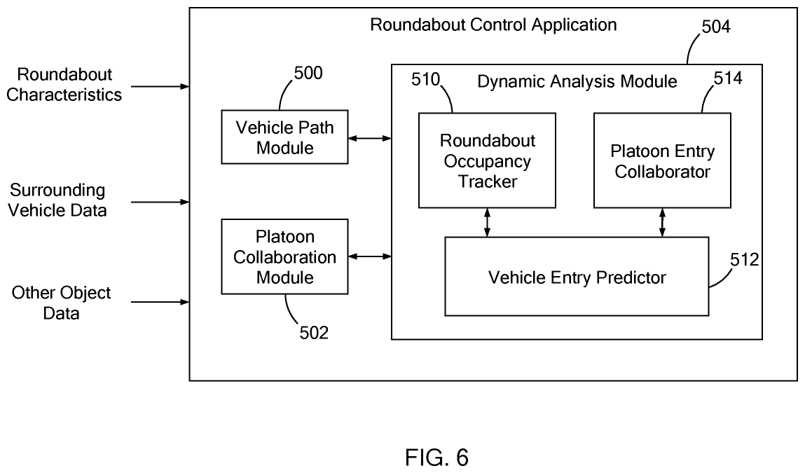

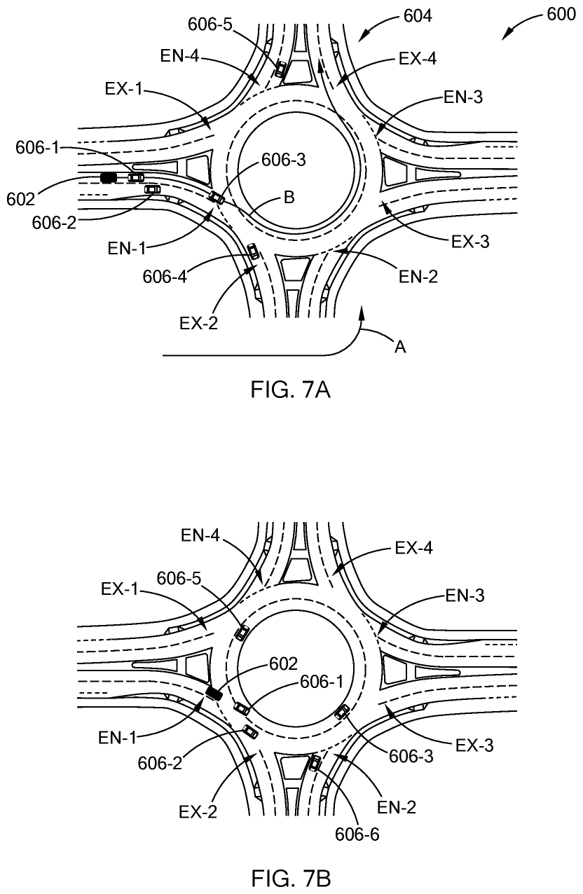

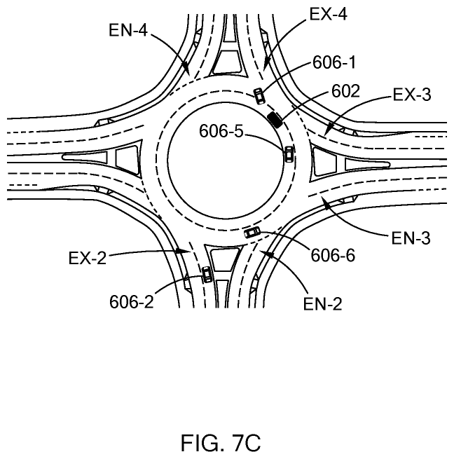

Referring to FIG. 6, in one form, the roundabout control application 414 is configured to have a vehicle path module 500, a platoon collaboration module 502, and a dynamic analysis module 504. In one form, the modules 500, 502, and 504 are provided as software programs executed by one or more processors of the vehicle control system 312. The following description is described with reference to FIGS. 7A to 7C which illustrate a system 600 having a subject vehicle 602 approach a roundabout 604 along with other vehicles 606 (i.e., surrounding vehicles). In one example, the system 600 is configured as system 100 of FIG. 1 and the subject vehicle 602 and the other vehicles 606 are configured as the vehicle 300 of FIG. 4 and include the roundabout control application 414. In another form, while the subject vehicle 602 is provided as a fully autonomous vehicle, the other vehicles 606 may have different levels of automation. That is, the roundabout control application of the present disclosure is operable in a system having mixed levels of automation.

The vehicle path module 500 is configured to define a roundabout path plan for traveling through the roundabout based on the roundabout characteristics, the dynamic characteristics of the vehicle, and/or the travel route of the vehicle. The roundabout characteristics may be acquired from the map repository 340 and/or from the roundabout control system. In one form, the travel route is provided by the navigation module 330, and the dynamic characteristics of the vehicle 300 is gathered from other modules of the vehicle control system and/or sub-systems of the vehicle. For example, the travel direction and location are provided by the navigation module and the speed is provided by the drive system.

In one form, to traverse the roundabout, the vehicle path module 500 identifies the entry point and exit point of the roundabout based on the roundabout characteristics and the travel route of the vehicle. As an example, in FIG. 7A, the roundabout 602 is a two-lane roundabout with entry points EN-1, EN-2, EN-3, and EN-4, and exit points EX-1, EX-2, EX-3, and EX-4. The subject vehicle 602 is following a travel route which is generally identified by arrow A, and has the vehicle 602 exiting the roundabout 602 via exit point EX-3. In one form, based on the roundabout characteristics, the position and direction of the subject vehicle 600, the vehicle path module 500 identifies the entry point of the subject vehicle 600 as EN-1 and defines a roundabout path plan (generally identified by arrow B) for having the subject vehicle 600 enter the roundabout at the identified entry point EN-1 and exit at the identified exit point EX-4.

In one form, the vehicle path module 500 is configured to define the roundabout path plan in a similar manner as a navigation system defines a travel route. In another form, the vehicle path module 500 is configured to obtain the roundabout path plan from the travel route by defining the roundabout path plan as a portion of the travel route between the entry and exit points of the roundabout 602. In one form, the roundabout path plan may also extend before the entry point to define the approach of the vehicle 602 to the entry point and/or extend after the exit point to define the exit of the vehicle 602.

In one form, the vehicle path module 500 defines an entry path of the subject vehicle 602 which provides the path taken by the subject vehicle 602 to enter the roundabout such that it may exit at the identified exit point. The entry path is part of the roundabout path plan and may begin a set distance (e.g., 10 to 100 m, or other suitable distance) before the entry point and end along one of the lanes encircling the roundabout 602. The roundabout path plan may be provided as a completion goal for traversing the roundabout 602 and the entry path may be provided as a partial goal for entering the roundabout 602.

The platoon collaboration module 502 is configured to determine whether a platoon for entering and/or traversing the roundabout can be formed with other vehicles. That is, via vehicle-to-vehicle communication, vehicles traversing the roundabout and those in que at entry points may share their respective completion goals for traversing the roundabout and partial goals for entering the roundabout with one another. Accordingly, the platoon collaboration module 502 transmits the roundabout path plan to other vehicles and determines if one of the other vehicles is a platoon candidate vehicle for the subject vehicle. More particularly, in one form, the platoon collaboration module 502 correlates the location, the travel direction, entry point, exit point, and/or roundabout path plan of the other vehicles with that of the subject vehicle to identify platoon candidate(s) that are in proximity to the subject vehicle and/or share the same entry point, exit point, and/or roundabout path plan.

For example, referring to FIG. 7A, the subject vehicle 602 acquires the roundabout path plan and determines dynamic characteristics of the other vehicles 606. In one form, based on the location, direction, and roundabout path plan of the other vehicles 606, the platoon collaboration module 502 determines that vehicles 606-1 and 606-2 are platoon candidates since the vehicles 606-1 and 606-2 are approaching the same entry point EN-1 as that of the subject vehicle 602. The other vehicles may not be platoon candidates because vehicle 606-3 is in the midst of entering the roundabout via EN-1, vehicle 606-4 is exiting at EX-2, and vehicle 606-5 is entering from another entry point, EN-4. Once identified, the platoon collaboration module 502 takes steps to inquire whether the platoon candidates would like to form a platoon (e.g., initiates a handshake to form a platoon).

In one form, the dynamic analysis module 504 is configured to perform a dynamic analysis of dynamic traffic flow of the roundabout to determine an entry parameter for the platoon or the subject vehicle if the platoon is not defined. More particularly, the dynamic analysis module 504 is configured to have a deep neural network or in other words, artificial intelligence to provide the predictive control for predicting position, path, and/or other characteristics of the other vehicles and for providing proactive moderation of traffic speed and flow to improve efficiency of platooning and improve traffic flow. In one form, the deep neural network is based on reinforcement learning and, more particularly, reinforcement learning in a Q-network. Q learning networks learn a policy to instruct the agent (in this case a vehicle) what action to take under specific circumstances. Q learning is not formula constrained and is therefore may be model free, which makes these types of reinforcement learning networks favorable for stochastic transitions. In one form, the artificial intelligence is agent based and capable of independent and collaborative analysis and traverse of the roundabout.

In one form, the dynamic analysis module 504 is configured to operate as a roundabout occupancy tracker 510, a vehicle entry predictor 512, and a platoon entry collaborator 514. The roundabout occupancy tracker 510 determines a dynamic traffic flow of the roundabout based on dynamic characteristics of moving objects.

The vehicle entry predictor 514 predicts the future near-term position and path of other vehicles to determine the entry parameter which includes an entry time and an occupancy gap for vehicles in the platoon. The vehicle entry predictor 514 further analyzes the entry points to determine if other vehicles will be entering the roundabout at the other entry points and predicts the path and position of those vehicles to determine, for example, if the other vehicles will be interfering with the platoon. The occupancy gap is defined as a gap in traffic flow for allowing the platoon or the subject vehicle enter the roundabout. Accordingly, the number of vehicles in a platoon is dependent upon the occupancy gap. In one form, the speed of vehicles through the roundabout may be moderated to create the occupancy gap to improve the efficiency of the platoon.

The platoon entry collaborator 512 determines whether the platoon agrees to an entry parameter. More particularly, each member of the platoon determines an entry parameter and shares it along with other data with members of the platoon. In one form, the other data may include predicted positions of other vehicles and/or moving objects (e.g., pedestrian, cyclist, etc.). The platoon entry collaborator 512 analyzes the entry parameters and the other data and determines if at least one of the entry parameters allows the platoon to enter the roundabout in a safe conclusive manner. That is, the predicted entry time and occupancy gap should allow the platoon to enter the roundabout without, for example, interfering with oncoming traffic, and colliding with other vehicles. If so, the platoon entry collaborator 512 identifies the entry parameter to be used and requests confirmation from members of the platoon. The entry parameter is then used by the autonomous drive module 330 to move the subject vehicle at the agreed upon entry time within the defined occupancy gap based on the roundabout path plan for the subject vehicle.

Referring to FIG. 7B, in this example, the subject vehicle 602 forms a platoon with vehicles 606-1 and 606-2 and enters the roundabout 604. In addition, vehicle 606-4 is no longer shown since it has exited the roundabout 604 via EX-2, and a new vehicle 606-6 is at entry point EN-2. In one form, the roundabout control application is configured to continuously analyze and map the dynamic traffic flow of the roundabout 604 and, if appropriate, form a platoon with other vehicles 606. For example, in FIG. 7C, vehicle 606-2 exits the roundabout at EX-2, and thus, leaves the platoon. The subject vehicle 602 is to exit the roundabout at EX-4 and after communication with the other vehicles, identifies vehicles 606-1 and 606-5 as also leaving the roundabout 604 at EX-4. Accordingly, the three vehicles may form another platoon to traverse the roundabout and exit via EX-4.

In the event the platoon is not able to select an entry parameter, the dynamic analysis module 504 may recalculate the entry parameter, instruct the platoon collaboration module to form a new platoon, and/or dissolve the platoon and determine entry parameter for only the subject vehicle.

The system having a vehicle with the roundabout control application of the present disclosure provides a multi-agent cognitive cooperative collaborative intelligent algorithm to queue and regulate traffic flow in a roundabout.

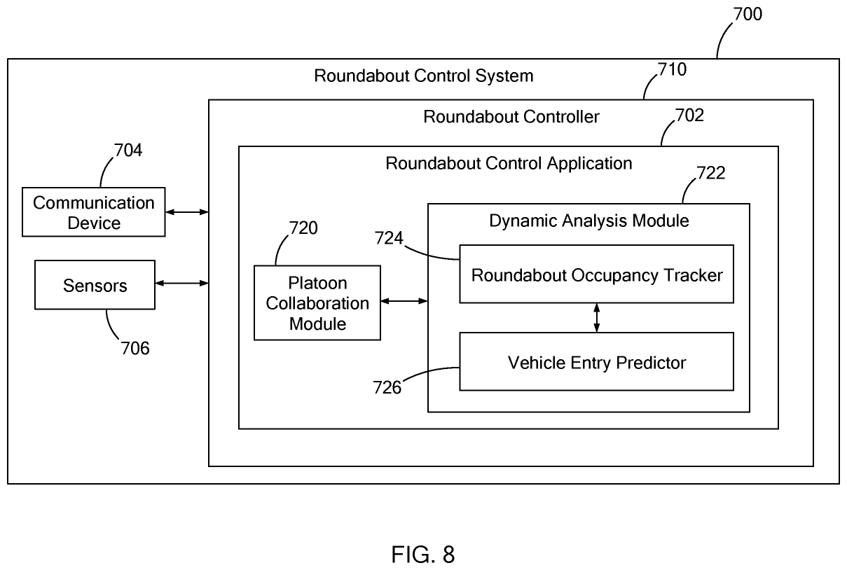

In another form of the present disclosure, a roundabout control application of the present disclosure may be provided with a roundabout control system to analyze data from vehicles approaching and traversing the roundabout and predict entry parameters and roundabout path plans for the vehicles. The vehicles then traverse through the roundabout based on the entry parameters and defined roundabout path plan. As an example, FIG. 8 illustrates a roundabout control system 700 having a roundabout control application 702. The roundabout control system 700 may be used in the system 100 of FIG. 1 and system 600 of FIGS. 7A to 7D.

In one form, the roundabout control system 700 includes a communication device 704, sensors 706, and a roundabout controller 710 that stores roundabout control application 702 in a memory (not shown) and executes the roundabout control application to control traffic through the roundabout. The communication device 704 and the sensors 706 may be configured in a similar manner as the communication device 200 and sensors 202 of FIG. 3. Similar to the roundabout controller 204, the roundabout controller 710 may be a computing device mounted at the roundabout. In another form, the roundabout controller 710 is part of a cloud-based network comprising servers configured to store data and compute traffic characteristics, such as arterial traffic density and traffic flow, among other information. The roundabout controller 710 is provided at the cloud edge in vicinity of the roundabout.

In one form, the roundabout control system 702 includes a platoon collaboration module 720 and a dynamic analysis module 722. The platoon collaboration module 720 is configured to identify one or more platoons for entering and/or traversing through the roundabout. For example, vehicles approaching and/or traversing the roundabout send messages that include travel information and drive characteristics of the vehicle. In one form, the drive characteristics include speed, travel direction, and/or location, and the travel information includes a completion goal, a final destination, and/or a travel route. The platoon collaboration module 702 defines roundabout paths for each vehicle and defines one or more platoons by correlating the location, the travel direction, entry point, and/or exit point of the vehicles.

The dynamic analysis module 722 is configured to perform a dynamic analysis of the traffic flow of the roundabout to determine an entry parameter for the platoon or a subject vehicle if the platoon is not defined. Like the dynamic analysis module 504, dynamic analysis module 722 utilizes machine learning to provide predictive control for predicting position, path, and/or other characteristics of the vehicles based on dynamic characteristics of various moving objects within the system.

In one form, the dynamic analysis module 722 is configured to operate as a roundabout occupancy tracker 724 and a vehicle entry predictor 726. Like roundabout occupancy tracker 510, roundabout occupancy tracker 724 determines a dynamic traffic flow of the roundabout based on dynamic characteristics of moving objects such as location, speed, travel direction, and roundabout path, among other information.

In one form, the vehicle entry predictor 726 operates in a similar manner as the vehicle entry predictor 514 to predict future near-term position and path of the vehicles to determine the entry parameter which includes an entry point time and an occupancy gap for the platoon(s). The vehicle entry predictor 726 transmits the respective entry parameter and roundabout path to each vehicle, and the vehicle autonomously controls the vehicle based on this information.

In one form, by having the roundabout control system 700, a vehicle is configured to determine whether the roundabout path plan is acquired, and if not may determine the roundabout path plan using the roundabout control application 414. In addition, if the vehicle follows the roundabout path plan from the roundabout control system 700 and detects an object in its path, the vehicle may abandon the roundabout path plan and resume independent automated vehicle control to inhibit possible collision with the object. Details regarding the object may also be transmitted to the other devices in the system, including the roundabout control system 700.

The locally placed roundabout control system is configured to plan and assist vehicles entering the roundabout to traverse the roundabout safely and efficiently. This may reduce the processing demands on the vehicle control systems while still permitting independent control of each vehicle.

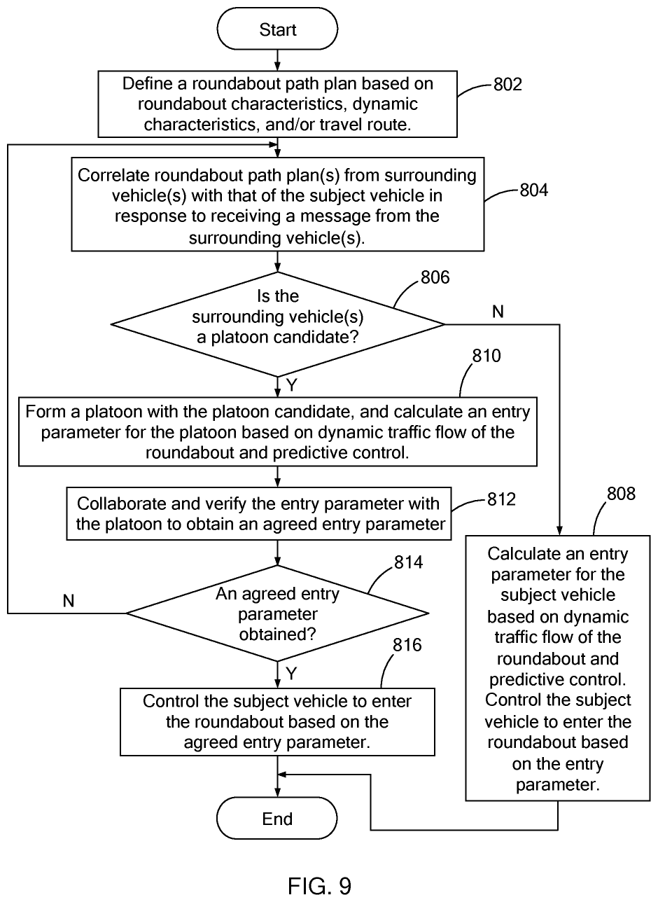

Referring to FIG. 9, an example roundabout control routine 800 is provided. In one form, the routine 800 is executed by a vehicle control system (VCS) having the roundabout control application of the present disclosure for a subject vehicle and is initiated when the subject vehicle is approaching a roundabout. At 802, the VCS defines a roundabout path plan based on the roundabout characteristics, dynamic characteristics, and/or travel route for the subject vehicle. In one form, using the travel route and the roundabout characteristics, the VCS determines an entry point and an exit point for the subject vehicle, and defines the roundabout path plan using the entry point, the exit point, the dynamic characteristics (e.g., position and travel direction), and/or the travel route. For example, the VCS obtains a map of the roundabout that provides the roundabout characteristics from the roundabout control system and the VCS correlates the travel route of the vehicle with the map to determine the appropriate entry point and/or exit point. At 804, the VCS correlates roundabout path plan(s) from surrounding vehicle(s) with that of the subject vehicle in response to receiving a message from the surrounding vehicle(s). That is, the subject vehicle may receive a message from one or more surrounding vehicles and the message may include the roundabout path plan for the surrounding vehicle along with dynamic characteristics of the surrounding vehicle. In another form, the message may include dynamic characteristics and the VCS is configured to at least determine an entry point and/or an exit point for the surrounding vehicle based on a position and travel direction of the surrounding vehicle.

At 806, the VCS determines if the surrounding vehicle is a platoon candidate. For example, as described above, the VCS correlates the information to determine if the surrounding vehicle has the same entry point, exit point, and/or have overlapping roundabout path plans. If so, the surrounding vehicle can be provided as a platoon candidate. The analysis of 804 and 806 is provided for each surrounding vehicle that the subject vehicle received a message from.

If none of the surrounding vehicles is a platoon candidate or if no message is received, the VCS, at 808, calculates an entry parameter for the subject vehicle based on the dynamic traffic flow of the roundabout and predictive control, as described above. The VCS further controls the subject vehicle to enter the roundabout based on the entry parameter. For example the subject vehicle enters the roundabout at the defined entry time and follows the roundabout path plan.

If there is a platoon candidate, at 810, the VCS forms a platoon with the platoon candidate(s) and calculate an entry parameter for the platoon based on dynamic traffic flow of the roundabout and predictive control, as described above. At 812, the VCS collaborates and verifies the entry parameter it determined with that provided by members of the platoon. For example, the VCS analyzes the entry parameters from the other platoons to determine if the platoon may enter the roundabout at the define entry time based on the defined occupancy gap. If at least one of the entry parameter is acceptable, the VSC request verification that the acceptable entry parameter be used as an agreed entry parameter, at 814. If an agreed entry parameter is obtained, the VSC controls the subject vehicle to enter the roundabout based on the agreed entry parameter, at 816. If no agreement is reached, the VCS may return to 804 to correlated roundabout path plans to form a platoon. In another form, the VCS may go to 808 to calculate an entry parameter for the subject vehicle. It should be readily understood that the routine 800 is just one example implementation of the roundabout control application, and other control routines may be implemented. For example, after controlling the subject vehicle to enter the roundabout, the routine may correlate the roundabout path plans to determine if a platoon can be formed to traverse the roundabout toward the exit point.

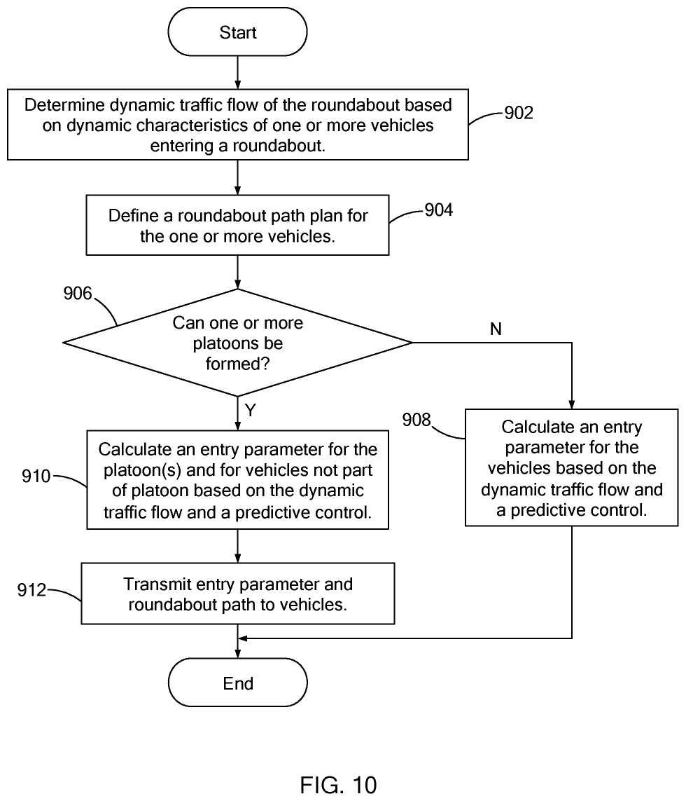

Referring to FIG. 10, an example roundabout control routine 900 is provided for a roundabout control system (RCS). The routine may be executed when one or more vehicles are approaching the roundabout. At 902, the RCS determines dynamic traffic flow of the roundabout based on dynamic characteristics of one or more vehicles entering a roundabout. As provided above, the dynamic characteristic includes information related to one or more vehicles entering a roundabout, and can include location, speed, and travel direction, among other characteristics. At 904, the RCS defines a roundabout path plan for the vehicles as described above. At 906, the RCS determines whether a platoon can be formed. Such determination can be formed based on the roundabout path plan. More particularly, in one form, the RCS correlates at least one of a roundabout path plan, an exit point, or an entry point of each vehicle to identify platoon vehicles that have the same entry point, same exit point, overlapping roundabout path plan, or a combination thereof. If a platoon cannot be formed, at 908, the RCS calculates an entry parameter for the vehicles based on the dynamic traffic flow and predictive control, as described above. If a platoon can be formed, the RCS calculates an entry parameter for the platoon(s) based on the dynamic traffic flow and predictive control. At 912, the RCS transmits the entry parameter and the roundabout path plan to respective vehicles. It should be readily understood that the routine 900 is just one example implementation of a roundabout control application for an RCS, and other control routines may be implemented.

Based on the foregoing, the following provides a general overview of the present disclosure and is not a comprehensive summary. In one form, the present disclosure is directed toward a method that includes: defining a roundabout path plan for a subject vehicle based on roundabout characteristics, dynamic characteristics, an entry point of the roundabout, an exit point of the roundabout, or a combination thereof; determining whether a platoon can be formed with at least one surrounding vehicle based on the roundabout path plan; calculating an entry parameter for the platoon in response to determining that the platoon can be formed based on dynamic traffic flow of the roundabout and a predictive control; collaborating and verifying the entry parameter with the platoon to obtain an agreed entry parameter; and controlling the subject vehicle to enter the roundabout based on the agreed entry parameter. The entry parameter includes an entry time and an occupancy gap, and the predictive control is configured to predict position and path of the subject vehicle and the at least one surrounding vehicle based on the dynamic characteristics.

In another form, the method further includes receiving a message that includes characteristics of the at least one surrounding vehicle, and determining dynamic characteristics of the at least one surrounding vehicle based on the message, wherein the dynamic characteristics include speed, travel direction, position, or a combination thereof.

In yet another form, the dynamic characteristics include at least one of speed, travel direction, or position for the subject vehicle, the at least one of surrounding vehicle, or a combination thereof.

In one form, determining whether the platoon can be formed with at least one adjacent vehicle further includes: correlating at least one of a roundabout path plan, an exit point, or an entry point of each of the surrounding vehicles with that of the subject vehicle to identify a platoon candidate, where the platoon candidate is a vehicle at the same entry point of the roundabout as the subject vehicle; and forming the platoon with the platoon candidate.

In another form, the roundabout characteristics include information indicative of a geometry of the roundabout, a type of the roundabout, or a combination thereof.

In yet another form, the collaborating and verifying further includes: obtaining one or more recommended entry parameters from members of the platoon; verifying the recommended entry parameter obtained based on the roundabout characteristics and the dynamic characteristics; and selecting the agreed entry time from among the recommended entry parameters and the entry parameter of the subject vehicle when at least one of the occupancy gaps allows the platoon to enter the roundabout at the entry time.

In one form, the predictive control is based on a trained artificial neural network.

In another form, the method further includes calculating an entry time for the subject vehicle based on the dynamic traffic flow of the roundabout and the predictive control in response to determining that the platoon cannot be formed.

In one form, the present disclosure is directed toward a vehicle control system for a subject vehicle. The vehicle control system includes a controller configured to: define a roundabout path plan for traversing a roundabout based on roundabout characteristics, dynamic characteristics of the subject vehicle, an exit point of the roundabout, or a combination thereof; determine whether a platoon can be formed with at least one surrounding vehicle based on the roundabout path plan; calculate an entry parameter for the platoon in response to determining that the platoon can be formed based on dynamic traffic flow of the roundabout and a predictive control, where the entry parameter includes an entry time and an occupancy gap between members of the platoon, and the predictive control is configured to predict position and path of the subject vehicle and the at least one surrounding vehicle based on dynamic characteristics; collaborate and verify the entry parameter with the platoon to obtain an agreed entry parameter; and control the subject vehicle to enter the roundabout based on the agreed entry parameter.

In another form, the controller is configured to determine dynamic characteristics of the at least one surrounding vehicle based on a received message that includes characteristics of the at least one surrounding vehicle, wherein the dynamic characteristics include speed, travel direction, position, or a combination thereof.

In yet another form, to determine whether the platoon can be formed, the controller is further configured to: correlate at least one of a roundabout path plan, an exit point, or an entry point of each of the at least one surrounding vehicles with that of the subject vehicle to identify a platoon candidate, where the platoon candidate is a surrounding vehicle at the same entry point of the roundabout as the subject vehicle; and form the platoon with the platoon candidate.

In one form, to collaborate and verify the entry parameter, the controller is further configured to: obtain a recommended entry parameter from each member of the platoon; verify the recommended entry parameter obtained based on the roundabout characteristics and the dynamic characteristics; and select the agreed entry time from among the recommended entry parameters and the entry parameter of the subject vehicle when at least one of the occupancy gaps allows the platoon to enter the roundabout at the entry time.

In another form, the controller is further configured to calculate an entry time for the subject vehicle based on the traffic flow of the roundabout and the predictive control in response to determining that the platoon cannot be formed.

In one form, the present disclosure is directed toward a method that includes: determining dynamic traffic flow of the roundabout based on dynamic characteristics, where the dynamic characteristics include information related to one or more vehicles entering a roundabout; defining a roundabout path plan for each of the one or more vehicles based on an entry point of the vehicle, an exit point of the vehicle, or a combination thereof; calculating an entry parameter for the one or more vehicles based on the traffic flow and a predictive control, where the entry parameter includes an entry time and an occupancy gap for having the vehicle enter the roundabout, and the predictive control is configured to predict position and path of each of the vehicles; and transmitting the entry parameter and the roundabout path plan to respective vehicles.

In another form, the method further includes: acquiring travel information for the one or more vehicles, wherein the travel information provides a completion goal, a final destination, a travel route, or a combination thereof; and determining the entry point and the exit point for the one or more vehicles based on the travel information.

In yet another form, the method further includes determining whether one or more platoons can be formed based on the roundabout path plan. The entry parameter is calculated for the platoon and includes the entry time. In one variation, to determine whether the one or more platoons can be formed, the method further includes correlating at least one of a roundabout path plan, an exit point, or an entry point of each vehicle to identify platoon vehicles having the same entry point, same exit point, overlapping roundabout path plan, or a combination thereof. The entry time is determined for the identified platoon vehicles.

The description of the disclosure is merely exemplary in nature and, thus, variations that do not depart from the substance of the disclosure are intended to be within the scope of the disclosure. Such variations are not to be regarded as a departure from the spirit and scope of the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The apparatuses and methods described in this application may be partially or fully implemented by a special purpose computer created by configuring a general purpose computer to execute one or more particular functions embodied in computer programs.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

What is claimed is:

1. A method comprising:
defining a roundabout path plan for a subject vehicle based on roundabout characteristics, dynamic characteristics, an entry point of the roundabout, an exit point of the roundabout, or a combination thereof;
determining whether a platoon can be formed with at least one surrounding vehicle based on the roundabout path plan;
calculating an entry parameter for the platoon in response to determining that the platoon can be formed based on dynamic traffic flow of the roundabout and a predictive control, wherein the entry parameter includes an entry time and an occupancy gap, and the predictive control is configured to predict position and path of the subject vehicle and the at least one surrounding vehicle based on the dynamic characteristics;
collaborating and verifying the entry parameter with the platoon to obtain an agreed entry parameter; and
controlling the subject vehicle to enter the roundabout based on the agreed entry parameter.

2. The method of claim 1 further comprising:
receiving a message that includes characteristics of the at least one surrounding vehicle; and
determining dynamic characteristics of the at least one surrounding vehicle based on the message, wherein the dynamic characteristics include speed, travel direction, position, or a combination thereof.

3. The method of claim 1, wherein the dynamic characteristics include at least one of speed, travel direction, or position for the subject vehicle, the at least one of surrounding vehicle, or a combination thereof.

4. The method of claim 1, wherein the determining whether the platoon can be formed with at least one adjacent vehicle further comprises:
correlating at least one of a roundabout path plan, an exit point, or an entry point of each of the surrounding vehicles with that of the subject vehicle to identify a platoon candidate, wherein the platoon candidate is a vehicle at the same entry point of the roundabout as the subject vehicle; and
forming the platoon with the platoon candidate.

5. The method of claim 1, wherein the roundabout characteristics include information indicative of a geometry of the roundabout, a type of the roundabout, or a combination thereof.

6. The method of claim 1, wherein the collaborating and verifying further comprises:
obtaining one or more recommended entry parameters from members of the platoon;
verifying the recommended entry parameter obtained based on the roundabout characteristics and the dynamic characteristics; and
selecting the agreed entry time from among the recommended entry parameters and the entry parameter of the subject vehicle when at least one of the occupancy gaps allows the platoon to enter the roundabout at the entry time.

7. The method of claim 1, wherein the predictive control is based on a trained artificial neural network.

8. The method of claim 1 further comprising calculating an entry time for the subject vehicle based on the dynamic traffic flow of the roundabout and the predictive control in response to determining that the platoon cannot be formed.

9. A vehicle control system for a subject vehicle, the vehicle control system comprising:
a controller configured to:
define a roundabout path plan for traversing a roundabout based on roundabout characteristics, dynamic characteristics of the subject vehicle, an exit point of the roundabout, or a combination thereof,
determine whether a platoon can be formed with at least one surrounding vehicle based on the roundabout path plan;
calculate an entry parameter for the platoon in response to determining that the platoon can be formed based on dynamic traffic flow of the roundabout and a predictive control, wherein the entry parameter includes an entry time and an occupancy gap between members of the platoon, and the predictive control is configured to predict position and path of the subject vehicle and the at least one surrounding vehicle based on dynamic characteristics;
collaborate and verify the entry parameter with the platoon to obtain an agreed entry parameter; and
control the subject vehicle to enter the roundabout based on the agreed entry parameter.

10. The vehicle control system of claim 9, wherein the controller is configured to determine dynamic characteristics of the at least one surrounding vehicle based on a received message that includes characteristics of the at least one surrounding vehicle, wherein the dynamic characteristics include speed, travel direction, position, or a combination thereof.

11. The vehicle control system of claim 9, wherein the dynamic characteristics include at least one of speed, travel direction, or position for the subject vehicle, the at least one surrounding vehicle, or a combination thereof.

12. The vehicle control system of claim 9, wherein to determine whether the platoon can be formed, the controller is further configured to:
correlate at least one of a roundabout path plan, an exit point, or an entry point of each of the at least one surrounding vehicles with that of the subject vehicle to identify a platoon candidate, wherein the platoon candidate is a surrounding vehicle at the same entry point of the roundabout as the subject vehicle; and
form the platoon with the platoon candidate.

13. The vehicle control system of claim 9, wherein the roundabout characteristics include information indicative of a geometry of the roundabout, a type of the roundabout, or a combination thereof.

14. The vehicle control system of claim 9, wherein to collaborate and verify the entry parameter, the controller is further configured to:
obtain a recommended entry parameter from each member of the platoon;
verify the recommended entry parameter obtained based on the roundabout characteristics and the dynamic characteristics; and
select the agreed entry time from among the recommended entry parameters and the entry parameter of the subject vehicle when at least one of the occupancy gaps allows the platoon to enter the roundabout at the entry time.

15. The vehicle control system of claim 9, wherein the predictive control is based on a trained artificial neural network.

16. The vehicle control system of claim 9, wherein the controller is further configured to calculate an entry time for the subject vehicle based on the traffic flow of the roundabout and the predictive control in response to determining that the platoon cannot be formed.

17. A method comprising:
determining dynamic traffic flow of the roundabout based on dynamic characteristics, wherein the dynamic characteristics include information related to one or more vehicles entering a roundabout;
defining a roundabout path plan for each of the one or more vehicles based on an entry point of the vehicle, an exit point of the vehicle, or a combination thereof;
calculating an entry parameter for the one or more vehicles based on the traffic flow and a predictive control, wherein the entry parameter includes an entry time and an occupancy gap for having the vehicle enter the roundabout, and the predictive control is configured to predict position and path of each of the vehicles; and
transmitting the entry parameter and the roundabout path plan to respective vehicles.

18. The method of claim 17 further comprising:
acquiring travel information for the one or more vehicles, wherein the travel information provides a completion goal, a final destination, a travel route, or a combination thereof; and
determining the entry point and the exit point for the one or more vehicles based on the travel information.

19. The method of claim 17 further comprising determining whether one or more platoons can be formed based on the roundabout path plan, wherein the entry parameter is calculated for the platoon and includes the entry time.

20. The method of claim 19 wherein to determine whether the one or more platoons can be formed, the method further comprises correlating at least one of a roundabout path plan, an exit point, or an entry point of each vehicle to identify platoon vehicles having the same entry point, same exit point, overlapping roundabout path plan, or a combination thereof, wherein the entry time is determined for the identified platoon vehicles.
